(19) United States
(12) Patent Application Publication
(10) Pub. No.: US 2004/0248597 A1
(43) Pub. Date: Dec. 9, 2004

(54) Direct response system with instant messaging and role based contact lists for replacing a dispatch system

(76) Inventor: James Earl Mathis, Barrington, IL (US)

Correspondence Address: MOTOROLA INC, 600 NORTH US HIGHWAY 45, ROOM AS437, LIBERTYVILLE, IL, 60048-5343, US

(21) Appl. No.: 10/457,289

(22) Filed: Jun. 9, 2003

(51) Int. Cl. H04Q 7/20

(52) U.S. Cl. 455/466; 455/404.2

(57) ABSTRACT

The preferred embodiments of the present invention provide a direct response system with instant messaging and role based contact lists. An object of the present invention is to replace traditional dispatch systems. In preferred embodiments of the present invention, a user selects a generic role entry on a messaging client device (102) and establishes communication. The client device (102) transmits an electronic message addressed to a particular responder client device (202). The responder client device (202) address information is transmitted to the initiating client device (102) via a status update received from a public server (112).

### FIELD OF THE INVENTION

The present invention relates generally to wireless dispatch communication systems and instant message systems, and more particularly, to a direct response network and clients with instant messaging and role based contact lists.

### BACKGROUND OF THE INVENTION

An instant messaging (“IM”) system generally comprises a plurality of IM client devices coupled to an IM server or servers of a data network. IM systems typically provide the ability to track, transmit, and receive the presence status of users connected to the data network IM server.

A client device typically displays presence information associated with other users as a portion of a contact list or buddy list. Client device contact lists typically reside in a client device memory and may also reside in an IM server memory simultaneously or alternatively. Each entry in the contact list corresponds to a user of the IM system, or more specifically to the user's IM client device. IM systems may collect information and provide occasional updates to client device contact lists for certain portions of contact list information such as presence status or location.

At a minimum, an IM client device and its associated IM server track whether another device identified by the contact list is online and thus available to communicate, or off-line and thus unavailable. A client device may also display any other collected information as a portion of a contact list.

An IM client device user typically populates a client device contact list by entering known individual identifiers such as user names or screen names. Alternatively, a user may perform a search for user identifiers by entering various search criteria and retrieving a list of matching criteria from a network. After the contact list is populated with at least one entry, the user may initiate an IM communication by selecting an entry from the contact list, provided the selected user is at least present and available with respect to the IM system. In the IM system described above, it is presumed that a first user initiating communication with a second user has knowledge of the second user. For example, the first user must have knowledge of at least the second user's name, user name, screen name, or other information that is specific to the second user.

Unlike the above-described IM system, a first user may wish to use a contact list to establish communication with a second user based only upon role or job-responsibility of the second user. The above-described IM system would not be sufficient for this purpose because it requires prior knowledge about the second user's specific information in order to create a contact list entry for the second user.

A particular difficulty exists for users needing to communicate with emergency services or public safety personnel. Even if a first user had a contact list entry for a specific second user, for example a police officer or paramedic, the second user may not be present or available to respond to the first user's message. A plurality of criteria may likewise prevent quick communication with specific entries such as client device location, second user assignment status, or any other criteria associated with a specific user.

Users may try to solve the difficulty by using a search capability of the IM system to find user identifiers for the appropriate emergency services or public safety personnel. Unfortunately, the plurality of criteria used by modern computer-aided dispatch (CAD) systems for assignment of emergency service and public safety personnel to specific incidents are too complex for IM system search abilities to handle. For example, CAD systems require parameters including but not limited to beat, assigned areas, officer status, and estimated time of arrival. Furthermore, the appropriate search criteria may change over time and must be controlled by the emergency services and public safety agencies. In addition, the information necessary for doing a search may be confidential or sensitive information not available for public viewing. For example, a police agency may not allow the public to search for officers based on geographic location since such searches could be used to reveal officer locations.

Thus what is needed is a system for creating and managing job or functional role based contact list entries and communications, such that a user may establish communication with the most appropriate specific individual as determined by various parameters and attributes of the individual's functional role.

### BRIEF DESCRIPTION OF THE DRAWINGS

FIG. 1 is a block diagram of a public wireless communication system with an instant messaging server.

FIG. 2 is a block diagram of a private wireless communication system with an instant messaging server.

FIG. 3 is a block diagram of public and private wireless communication systems in accordance with preferred embodiments of the present invention.

FIG. 4. is a diagram illustrating an instant messaging client display of a role based contact list in accordance with a preferred embodiment of the present invention.

FIG. 5 is a diagram illustrating an instant messaging contact list database maintained by a server in accordance with a preferred embodiment of the present invention.

FIG. 6 is a flow diagram of server status updates for instant messaging clients of an instant messaging system in accordance with a preferred embodiment of the present invention.

FIG. 7 is a flow diagram of a first system operation in accordance with preferred embodiments of the present invention.

FIG. 8 is a flow diagram of a second system operation in accordance with preferred embodiments of the present invention.

FIG. 9 is a flow diagram of a third system operation in accordance with preferred embodiments of the present invention.

### DETAILED DESCRIPTION OF THE PREFERRED EMBODIMENTS

An apparatus and method for a direct response system with role defined contact lists in an instant messaging system are provided herein. In preferred embodiments of the present invention, a system user may initiate communications by means of role based contact list entries. The contact list entry will correspond to a job function or role for example; police, medical, electrician, plumber, and pizza delivery. An object of the present invention is to replace traditional dispatch systems where the caller does not have direct access to the responder.

In preferred embodiments of the present invention a network maintains and updates status information of responder client devices such that an appropriate responder will receive instant messages from appropriate callers. The appropriateness is determined by a variety of factors for example, location, assignment of the responder, and other factors associated with the particular role of the responder.

Typically the communications would consist of an exchange of instant messages between the caller and responder, however other communications means including the exchange of short-message service (SMS) messages could be used. The content of the communications may comprise various media types such as text, voice, images, video, location, and sensory and telemetry data, binary data, or other application specific data.

A first aspect of the present invention is a messaging system comprising: a first group of messaging clients each having a role based contact list for establishing communication with one of a responder group of messaging client devices; a responder server, suitable for tracking and transmitting messaging client status for the responder group; and an initiation server capable of receiving responder status updates and transmitting the updates as role based contact list updates to the first group of messaging client devices.

A second aspect of the present invention is a messaging client device that has a role based contact list that can be used to contact a responder by using the list. The messaging client contact list is also capable of receiving updates from a server.

A third aspect of the present invention is a responder-messaging client that can be assigned a role by a server, and communicate with messaging clients that use role based contact lists. The responder-messaging clients are also capable of transmitting status updates to a server.

A fourth aspect of the present invention is a method of establishing a messaging communication with a responder comprising the steps of: a user selecting a role entry of a contact list on a client device and initiating communication; transmitting a message from the client device to a first server, transmitting the message to a second server, and establishing messaging communication with a responder. The responder device will then transmit a status update to the second server, which is transmitted back to the first server. The status updates are used to promulgate role based contact list updates to the client devices.

A fifth aspect of the present invention is a method of establishing a messaging communication with a responder comprising the steps of: a user selecting a role entry of a contact list on a client device and initiating communication, transmitting a message from the client device to a responder client device, and establishing a messaging communication with the responder client wherein the responder client transmits digitally signed messages to the initiating client device. The responder device will also transmit a status update to a server.

A sixth aspect of the present invention is a role based contact list comprising a plurality for role entries. The role entries may contain either specific responder addressing information, or generic addressing information. In either case, the contact list may be used to establish a messaging communication with a responder corresponding to the selected role.

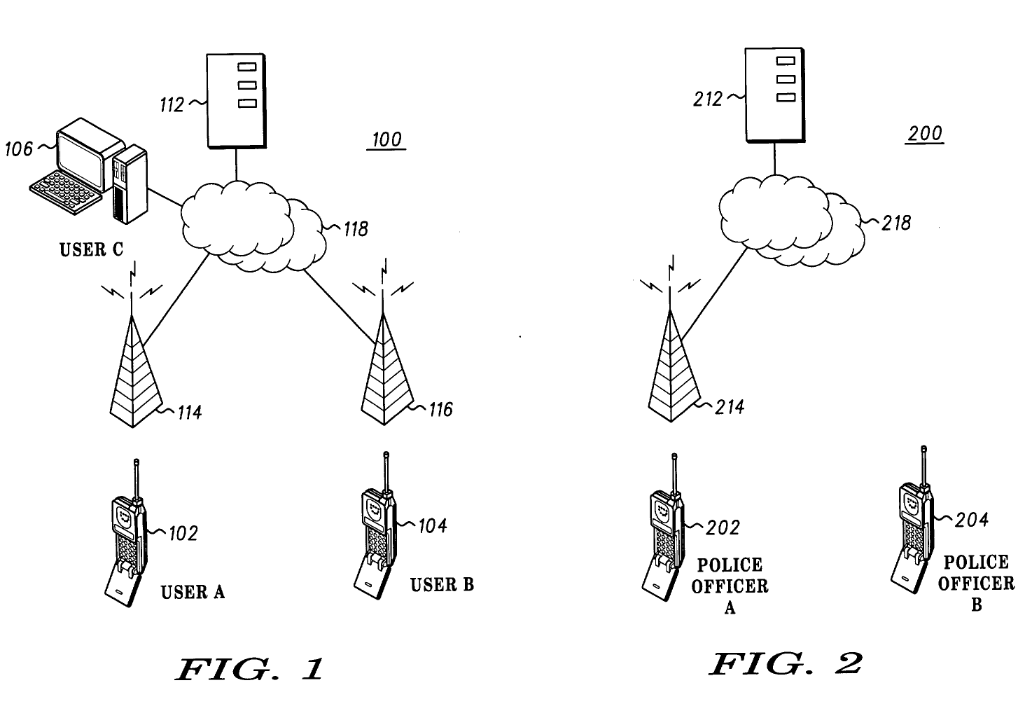

Turning now to the drawings where like numerals designate like components, FIG. 1 illustrates a plurality of client devices 102, 104, and 106 capable of communicating with other client devices (not shown) via a data communication network 100. The communication network 100 comprises a server 112 and a plurality of radio sub-networks 114 and 116. Radio sub-networks 114 and 116 are capable of communicating with server 112 via connectivity 118 which may be direct connectivity or connectivity via any suitable form of network, for example a cellular communication network, a wire-line telephone network, the Internet or a combination of networks. Client devices 102 and 104 communicate with radio sub-networks 114 and 116 via any suitable radio interface, for example CDMA, GSM, 802.11, and Bluetooth™. Client device 106, communicates with the network 100 via a wired connection and is capable of communicating with server 112 via connectivity 118.

It is to be understood that the preferred embodiments of the present invention are applicable to communication networks of various configurations. For example, the communications network may comprise a plurality of servers, a plurality of radio sub-networks, and may communicate with client devices via a combination of wired and wireless network connections. Therefore, the communications network 100 is for illustrative purposes only and is not to be construed as a limitation on the preferred embodiments.

Returning to FIG. 1, client devices 102, 104, 106 and server 112 each comprise at least one processor for general operation and a memory for storage of applications and data. Further, client devices 102, 104, and 106 each have an IM application residing in memory such that client devices 102, 104, and 106 each have an IM capability and IM role based contact lists.

In FIG. 1 for illustrative purposes, client devices 102, 104 and 106 represent a first user “A,” a second user “B,” and a third user “C” respectively. In FIG. 1, client device 102 and client device 104 are communicating with and coupled to radio sub-network 114 via a radio interface. Client device 106 is communicating with and coupled to network 100 via a wired connection. Client devices 102, 104 and 106 are also IM capable and have IM contact lists residing in a memory of each client device respectively. Client devices 102, 104 and 106 provide presence and status updates to server 112 which records and maintains the information. Server 112 in turn provides contact list updates to the client devices 102, 104 and 106 with respect to the client device contact list entries.

FIG. 2 illustrates a plurality of responder personnel client devices 202, 204 capable of communicating with other client devices (not shown) via a data communication network 210. The data communication network 210 may be a dedicated or private wireless communication network and may provide enhanced coverage, improved security, better quality of service, or lower cost of operations than that available from a public communications system.

The communication network 210 comprises a server 212 and a plurality of radio sub-networks. For illustrative purposes and clarity a single radio sub-network 214 is shown in FIG. 2. Radio sub-network 214 is capable of communicating with server 212 via connectivity 218, which, similar to connectivity 118, may be direct connectivity or connectivity via any suitable form of network. Because communications network 210 may be a dedicated or private wireless communication network with enhanced security, connectivity 218 may likewise have an enhanced security aspect such that the overall security integrity of communications 210 would be maintained. Responder client devices 202 and 204 communicate with radio sub-network 214 via a suitable radio interface, which may conform to a proprietary standard, a governmental standard, or a publicly available commercial standard.

It is to be understood that the communications network 210 may be of various configurations and remain in accordance with preferred embodiments of the present invention. For example, the communications network 210 may comprise a plurality of servers, a plurality of radio sub-networks, and may communicate with client devices via a combination of wired and wireless network connections. Therefore, the communications network 210 is for illustrative purposes only and is not to be construed as a limitation on the preferred embodiments.

Returning to FIG. 2, responder client devices 202, 204 and the server 212 each comprise at least one processor for general operation and a memory for storage of applications and data. Further, responder client devices 202 and 204 each have an IM application residing in memory such that responder client devices 202 and 204 each have an IM capability. Responder client devices 202 and 204 may also have EM role based contact lists.

In FIG. 2 for illustrative purposes, responder client devices 202 and 204 are emergency services and public safety client devices and represent Officer A and Officer B respectively. In FIG. 2, responder client devices 202 and 204 are communicating with and coupled to radio sub-network 214 via a radio interface. Responder client devices 202 and 204 are also IM capable and have IM contact lists residing in a memory of each client device respectively. Responder client devices 202, 204 provide presence and status updates to server 212 which records and maintains the information. Server 212 in turn provides contact list updates to the responder client devices 202 and 204 with respect to the client device contact list entries.

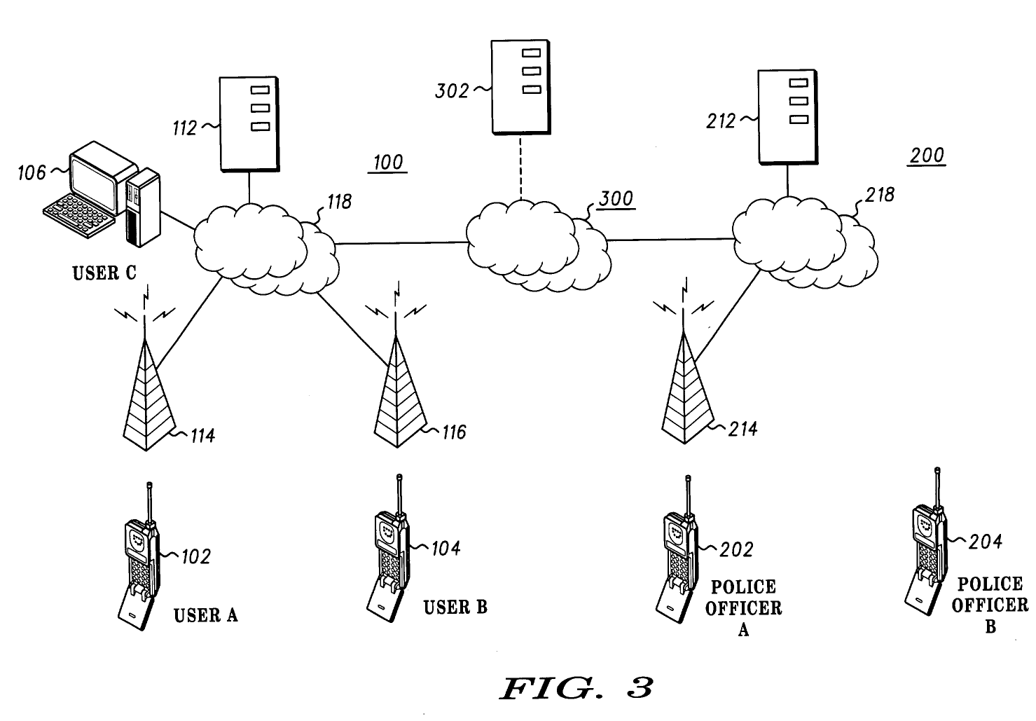

FIG. 3, illustrates an instant messaging system in accordance with preferred embodiments of the present invention. In FIG. 3, server 112 communicates with server 212 via communication means 300. Communication means 300 may be implemented by various methods and techniques such as a virtual private network, or a physical network. Server 112 and server 212 exchange presence and status update information using communication means 300.

Client devices 102, 104 and 106 may communicate with responder client devices 202 and 204 via connection means 300, which enables any client device communicating with network 100 to communicate with any client device communicating with network 200. In some preferred embodiments, the communication of client devices between network 100 and network 200 is managed by at least one of server 112 and 212, or by server 302.

Important to note is that the presence and status update information exchanged between server 112 and server 212 is transmitted and received by a secure communication means such that server 112 is able to trust the received information. Responder client devices 202 and 204 are authenticated such that unauthorized users are prevented from masquerading as emergency services and public safety personnel in particular, or other responders as necessary for desired levels of security. The secure communication means also prevents disclosure of the communications to, and tampering by, unauthorized third parties.

In FIG. 3, server 302 may be a trusted third-party server such that server 212 sends presence and status updates to server 302, and server 302 transmits the presence and status updates to server 112. Server 112 subsequently transmits the presence and status updates to the appropriate client devices communicating via network 100. Trusted third-party server 302 ensures that confidential user data such as location is not divulged to government or other organizations. Further, trusted third-party server 302 protects sensitive government information such as emergency services and public safety personnel status and location. Although FIG. 3 shows only a single trusted third-party server 302, many such servers could be utilized in preferred embodiments of the present invention.

In some preferred embodiments responder client devices 202 and 204 may communicate with public radio sub-networks 114 and 116. In this case, presence and status updates transmitted by responder client devices 202 and 204 to server 212 are digitally signed using encryption techniques and key information issued by a trusted source (not shown). The trusted source server may be part of the public radio network or remote.

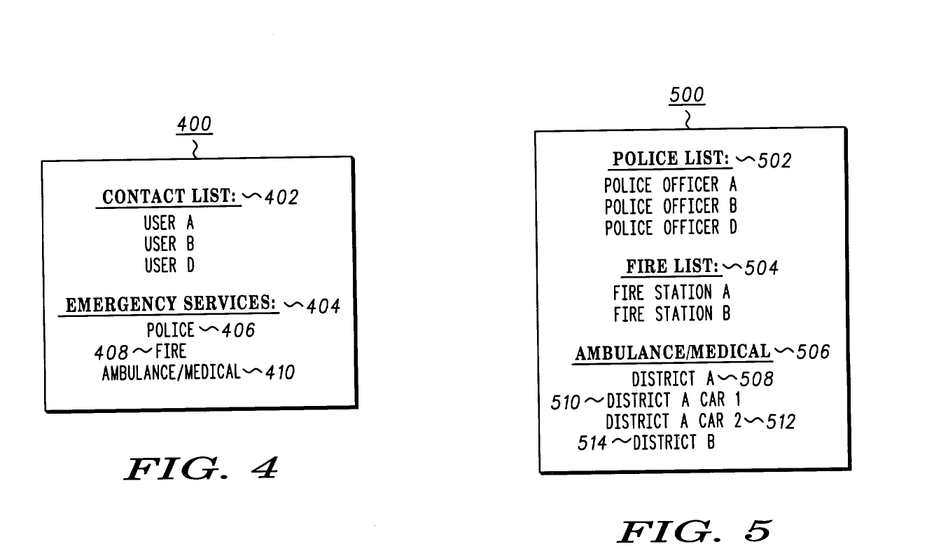

FIG. 4 illustrates the exemplary information contained in a contact list 400, or buddy list, of client devices 102, 104 and 106 in accordance with preferred embodiments of the present invention. Contact list 400 comprises fields for individual contacts 402, and for emergency services 404. The emergency services field 404 may be further comprised of specific service fields such as Police 406, Fire 408, and Ambulance/Medical 410. Other field definitions may also be utilized as appropriate for a specific service. For example, a special field or sub-field definition for non-emergency police communication may be utilized. Each entry, such as Police 406, will also comprise other information such as availability status (not shown) that is transmitted to client devices by server 112. Although FIG. 4 shows the contact list 400 fields as text for simplicity of illustration, it is to be understood that pictures, icons, or other appropriate forms of representation may be used for contact list entries in accordance with preferred embodiments of the present invention.

In FIG. 4, a user may initiate communications with emergency service personnel by selecting an emergency service 404 from contact list 400, and following an IM procedure of a client device. The IM procedure may comprise a verification step additional to what is required to establish communication with an entry of the individual contact list 402. This additional step would prevent inadvertent selection and communication establishment with the emergency services 404. In preferred embodiments the contact list 400 may be stored in a memory of a client device or in a memory of server 112.

FIG. 5 illustrates exemplary information maintained by server 212 and server 302. Dispatch database 500 may comprise information for a single service or for a plurality of services such as a Police List 502, Fire List 504, and Ambulance/Medical List 506. Other services may also be stored and maintained depending on the configuration of the IM system.

Individual service records may also further comprise layers of sub-records. For example, District A 508 and District B 514 subdivide Ambulance/Medical List 506. District A 508 further comprises District A Car 1 510 and District A Car 2 512. The levels of granularity, or the layers or recordation, are determined by the appropriate entities typically dispatched by the specific emergency or responder service. In accordance with the example of FIG. 5, Ambulance/Medical List 506 comprises ambulance information for “District A Car 1” and “District A Car 2,” such that either car may be dispatched for a given emergency.

The entities, such as “District A Car 1” further comprise CAD information such as assigned area, status, estimated time of arrival and any other CAD parameters appropriate for the specific emergency service. Dispatch database 500 CAD parameters are updated when client devices, such as client devices 202 and 204, transmit presence and status updates to server 212.

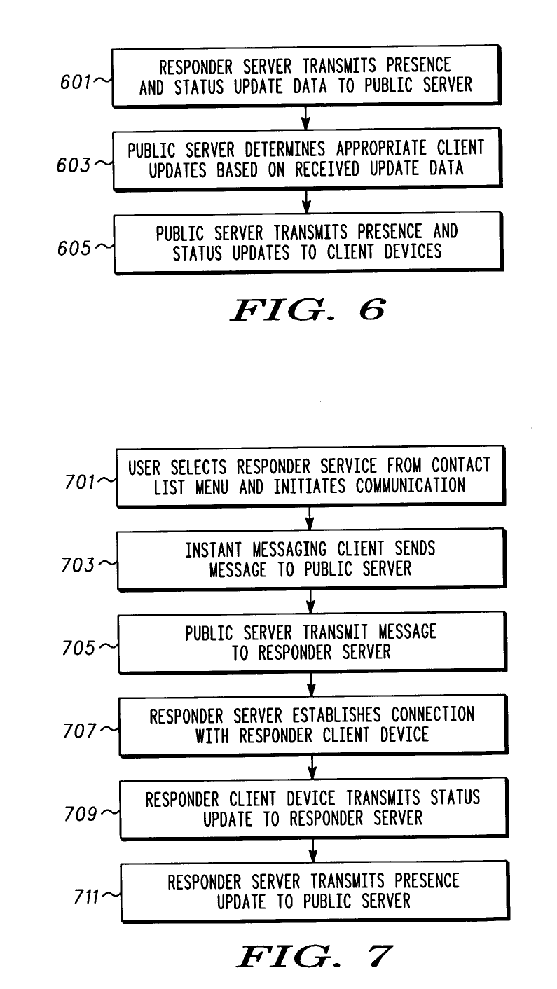

FIG. 6 illustrates the basic operation of status updates in accordance with preferred embodiments of the present invention. In block 601, a responder server, for example server 212, has received status update data from client devices, such as responder client devices 202 and 204. The status update data comprises presence and other CAD related data appropriate for the services specific to the responder client devices. In block 601, server 212 transmits the status update data to a public server, such as server 112.

In block 603, server 112 determines the appropriate client updates based on the data received from server 212. It is to be understood that in blocks 601 and 603, the data may be transmitted from server 212 to server 302, and from server 302 to server 112 in accordance with some preferred embodiments of the present invention. Further, the determination of the appropriate client updates may be determined by server 302 rather than server 112 in some preferred embodiments. Alternatively, server 212 may determine the appropriate client updates based upon data received by server 212 from server 112. Server 212 would, in that case, transmit completed status update information to server 112.

The appropriate client updates determined in block 603 comprise for example, location, availability, and other factors that consider status data of network 100 client devices in combination with the status data of network 200 responder client devices. For example, if User A is utilizing sub-network 114, and Police Officer A is available, and utilizing sub-network 214 which is physically near sub-network 114, then User A's client device 102 contact list Police 406 entry will be updated to correspond to Police Officer A's contact information. It is to be understood that the client device 102 contact list 400 may be transparently updated such that User A will only perceive a “Police” 406 entry in the emergency services 404 list. However, it is also to be understood that the Police 406 entry could alternatively be modified upon update to display some information specific to Police Officer A such as for example, Police Officer A's badge number. Alternatively, the Police 406 entry may comprise a sub-list, which would be updated to show Police Officer A as an entry.

In block 605, server 112 transits status updates to the client devices of network 100 based upon the determinations made by server 112, or as in some preferred embodiments, based upon the determinations made by server 302.

FIG. 7 illustrates an operation of service utilization in accordance with preferred embodiments of the present invention. In block 701, a user selects an emergency service 404 from client device contact list 400 and initiates communication. The client device IM client transmits, via network 100, a message to server 112 in block 703. In block 705, server 112 transmits the message to server 212 via connectivity 300 and network 200. In block 707, server 212 establishes communication with the appropriate network 200 responder client device, for example responder client device 202.

In block 709, Officer A, who is the operator of responder client device 202 in this example, responds. Responder client device 202 subsequently transmits a status update to server 212. In block 711, server 212 proceeds with the status update procedure described above with respect to FIG. 6.

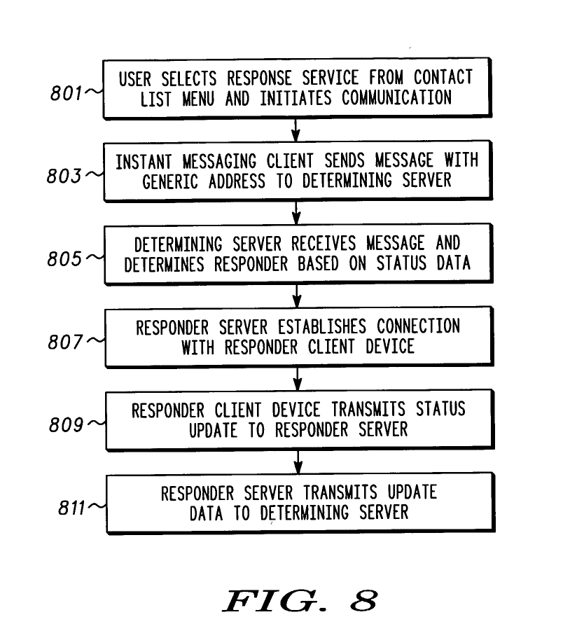

FIG. 8 illustrates a second operation of service utilization in accordance with the preferred embodiments and an alternative to that of FIG. 7. In block 801 a user initiates communication similar to block 701. Likewise, block 803 transmits a message to server 112 similar to block 703.

However, the message of block 803 is different than the message of block 703. Unlike the block 703 message which identifies a specific responder, the addressee of the block 803 message is generic. In block 805, a determining server receives the generic message, for example “police emergency” and determines the responder based upon the combination of status data for the network 100 client device and network 200 responder client devices.

The server that makes the appropriate determination, the determining server, could be server 112, server 212, or server 302 in accordance with preferred embodiments of the present invention. Further, in the embodiment of FIG. 8, the client devices of network 100 need not receive status updates from server 212. However, if availability or other emergency services list 404 display information were desirable, then status updates would be required. In that case, the status updates would not include specific responder information but only limited information such as general police availability.

In block 807 the server 212 establishes communication with a network 200 responder client device for example, responder client device 202. In block 809, the operator of responder client device 202 responds and client device 202 transmits a status update to server 212. In block 811, server 212 transmits the status update to the determining server. If server 212 is the determining server, then no status update is transmitted unless the limited status update is required as described above.

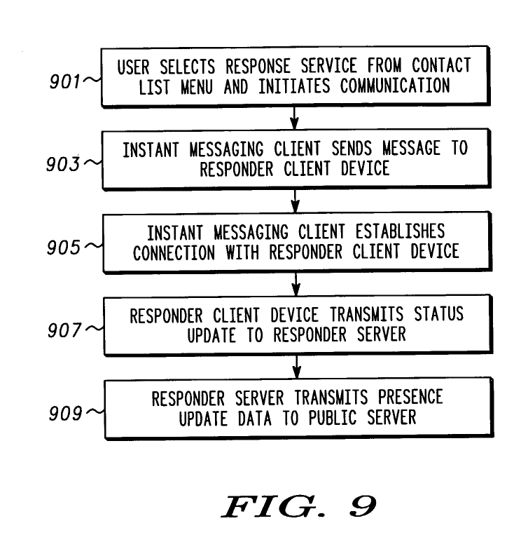

FIG. 9 illustrates a third operation of service utilization in accordance with the preferred embodiments and alternative to the operations of both FIG. 7 and FIG. 8. In block 901, a user initiates communication similar to block 701. Likewise in block 903 the client device transmits a message that identifies a specific responder client device similar to the message transmitted in block 703.

Unlike the block 703 message, the block 903 message is transmitted to the responder client device, for example, responder client device 202 rather than a server. As previously described, in some preferred embodiments responder client devices 202 and 204 may communicate with public radio sub-networks 114 and 116. In this case, messages transmitted by responder client devices 202 and 204 are digitally signed using encryption techniques and key information issued by a trusted source (not shown) to authenticate the source and contents of the messages. In block 905, a communication is established between the user client device and the specific responder device, for example client device 202, without intermediary servers.

In block 907, the operator of responder client device 202 responds and client device 202 transmits a status update to server 212. In block 909, server 212 proceeds with the status update procedure described above with respect to FIG. 6.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A messaging system comprising:
a first group of messaging client devices each having a role based contact list for establishing communication with one of a responder group of messaging client devices;
a responder server, suitable for tracking and transmitting messaging client status for said responder group of messaging client devices;
an initiation server, capable of receiving said status, and transmitting said status as role based contact list updates to said first group of messaging client devices.

2. The messaging system of claim 1, further comprising a trusted party server capable of receiving said status from said responder server and transmitting said status to said initiation server.

3. The messaging system of claim 2, wherein one of said initiator server, said responder server, and said trusted party server compares a status criteria of said first group of messaging client devices with said status of said responder group and determines said role based contact list updates based upon said comparison.

4. The messaging system of claim 1, wherein said status comprises location information, and computer aided dispatch system information corresponding to a role of said responder group of messaging client devices.

5. The messaging system of claim 1, wherein one of said initiator server and said responder server compares a status criteria of said first group of messaging client devices with said status of said responder group and determines said role based contact list updates based upon said comparison.

6. The messaging system of claim 5, wherein said comparison comprises comparing and correlating responder location, responder assignment, and responder presence with location of said first group.

7. The messaging system of claim 1, wherein said responder server is an emergency services and public safety server and said role based contact list of said first group of messaging client devices contains at least one of police, fire, and ambulance roles.

8. The messaging system of claim 1, further comprising a plurality of wireless networks and wherein said first group of messaging client devices and said responder group of messaging client devices communicate via a wireless interface.

9. The messaging system of claim 1, further comprising a trusted server for providing key information to said first group of messaging client devices and said responder group of messaging client devices such that a message transmitted from any of said responder group of client devices to any of said first group of messaging client devices is a digitally signed message.

10. A messaging client device having a role based contact list and capable of:
establishing communication with a second messaging client device by selecting an entry of said role based contact list; and
receiving an update of said role based contact list from a server.

11. The messaging client device of claim 10, wherein said update of said role based contact list comprises individual addressing information of said second messaging device.

12. The messaging client device of claim 10, wherein said update of said role based contact list comprises at least one generic role address suitable for identifying an individual responder by a responder server.

13. The messaging client device of claim 12, wherein said update of said role based contact list further comprises presence status information for display corresponding to said at least one generic role.

14. The messaging client device of claim 10, further comprising at least one radio interface for two-way communication with a network.

15. The messaging client device of claim 14, wherein said at least one radio interface is one of CDMA, GSM, 802.11, and Bluetooth.

16. A messaging client device capable of:
being assigned a role by a server;
communicating with a second messaging client device wherein said second messaging client device initiates communication by selecting a contact list entry corresponding to said messaging client's assigned role; and
transmitting a status update to a server.

17. The messaging client device of claim 16, further comprising a role based contact list.

18. The messaging client device of claim 16, further comprising at least one radio interface for two-way communications with a network.

19. The messaging client device of claim 18, wherein said at least radio interface is one of a proprietary radio interface standard, a governmental radio interface standard, CDMA, GSM, 802.11, and Bluetooth.

20. A method of establishing communication with a responder comprising the steps of:
selecting by a user, a role from a role based contact list of a messaging client device and following a procedure of the messaging client device for initiating communication;
transmitting a message from said messaging client device to a first server;
transmitting said message from said first server to a second server;
transmitting said message form said second server to a responder client device;
establishing a two-way messaging communication between said messaging client device and said responder client device;
transmitting a status update from said responder client device to said second server; and
transmitting a status update from said second server to said first server.

21. A method of establishing communication with a responder comprising the steps of:
selecting by a user, a role from a role based contact list of a messaging client device and following a procedure of the messaging client device for initiating communication;
transmitting a message from said messaging client device to a first server;
transmitting said message from said first server to a trusted party server;
transmitting said message from said trusted party server to a second server;
transmitting said message form said second server to a responder client device;
establishing a two-way messaging communication between said messaging client device and said responder client device;
transmitting a status update from said responder client device to said second server;
transmitting said status update from said second server to said trusted party server; and
transmitting said status update from said trusted party server to said first server.

22. A method of establishing communication with a responder comprising the steps of:
selecting by a user, a role from a role based contact list of a messaging client device and following a procedure of the messaging client device for initiating communication;
transmitting a message from said messaging client device to a responder client device;
establishing a two-way messaging communication between said messaging client device and said responder client device;
transmitting a status update from said responder client device to a first server; and
transmitting a status update from said first server to a second server.

23. The method of claim 22, wherein said message is digitally signed using key information issued from a trusted server.

24. A role based contact list comprising a plurality of role entries, each role entry containing addressing information of a corresponding responder and suitable for establishing a messaging communication with said responder.

25. A role based contact list comprising a plurality of roles, each role containing a generic addressing information suitable for a server to correlate with a corresponding responder and establish a messaging communication with said corresponding responder.
